(19) United States
(12) Patent Application Publication
(10) Pub. No.: US 2015/0348295 A1
(43) Pub. Date: Dec. 3, 2015

(54) DATA MANIPULATION CUES

(71) Applicant: Microsoft Corporation, Redmond, WA (US)

(72) Inventors: Chiu Ying Cheung, Redmond, WA (US); Amir Netz, Bellevue, WA (US); Moshe Golan, Haifa (IL)

(21) Appl. No.: 14/294,525

(22) Filed: Jun. 3, 2014

(51) Int. Cl. G06T 11/20; G06T 11/60

(52) U.S. Cl. CPC G06T 11/206; G06T 11/60

(57) ABSTRACT

At least one cue can be generated regarding manipulating representations of data. The cue provides information regarding manipulating a first representation of a first set of data with respect to a second representation of a second set of data based on correlations between the first set of data and the second set of data. Among other things, a cue can identify shift direction and distance, scale factor, and correlation strength.

### BACKGROUND

It is advantageous to identify correlations between different data sets, for instance for forecasting. One reason is the more data sets are correlated the more likely better results can be achieved at least in the context of forecasting. Correlation captures the strength of relation or dependency between two sets of data. For example, there can be a correlation between advertising and sales. Correlations can be identified by observing representations of data sets such as graphs for instance. Upon visual examination, an individual may be able to identify a pattern between data indicative of correlation between the data sets.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to data manipulation cues. Representations of data including but not limited to graphs can be manipulated independent of each other to facilitate alignment. Moreover, one or more cues can be provided that further aid alignment as well as understanding of relations between data sets, wherein a cue is a signal that supplies information that an individual may be interested in perceiving in the context of manipulation of a representation of data. Non-limiting examples include cues that identify a direction of shift, magnitude of a shift, strength of correlation, and scale factor.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a data manipulation system.

FIG. 2 is a block diagram of a representative cue component.

FIGS. 3 and 4 illustrate on exemplary scenario involving shifting of graphs and cues.

FIGS. 5-7 illustrate another exemplary scenario involving shifting of graphs and cues.

FIG. 8 is a flow chart diagram of a data manipulation method.

FIG. 9 is a flow chart diagram of a method of determining correlation values.

FIG. 10 is a schematic block diagram illustrating a suitable operating environment for aspects of the subject disclosure.

### DETAILED DESCRIPTION

A lapse between events often begets difficulties identifying and analyzing relations between data sets. One event may be dependent on another event but a lag can exist. By way of example, consider advertising and sales, wherein sales are affected by advertisement with a delay. In other words, advertising dollars spent will affect sales but not immediately. If advertising and sales data are visualized in a graph, one might be able to see a pattern in the data. However, it may be difficult to determine whether the pattern actually corresponds to correlation. Further, visual examination may be used to determine how close graphs are to each other, but there is no information with respect to how much lag exists. Similar difficulties can exist in analyzing relations between data sets that vary in scale.

Details below generally pertain to data manipulation cues. Representations of data sets, such as graphs, can be freely moveable with respect to each other in accordance with one aspect of the disclosure. For instance, overlaid graphs can be placed on separate axes to enable independent manipulation including at least shifting and scaling. Moreover, cues can be provided to aid alignment of data sets as well as understanding of relations between the data sets. A cue can provide information regarding manipulating a representation of one data set with respect a representation of another data set, for example based on correlations determined amongst the data sets. By way of example, and not limitation, a cue can identify shift direction and magnitude, scale factor, and correlation strength, among other things. A cue can thus help guide a user to interact with representations of data in a manner that saves time and eliminates manual steps in determining how to align representations.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

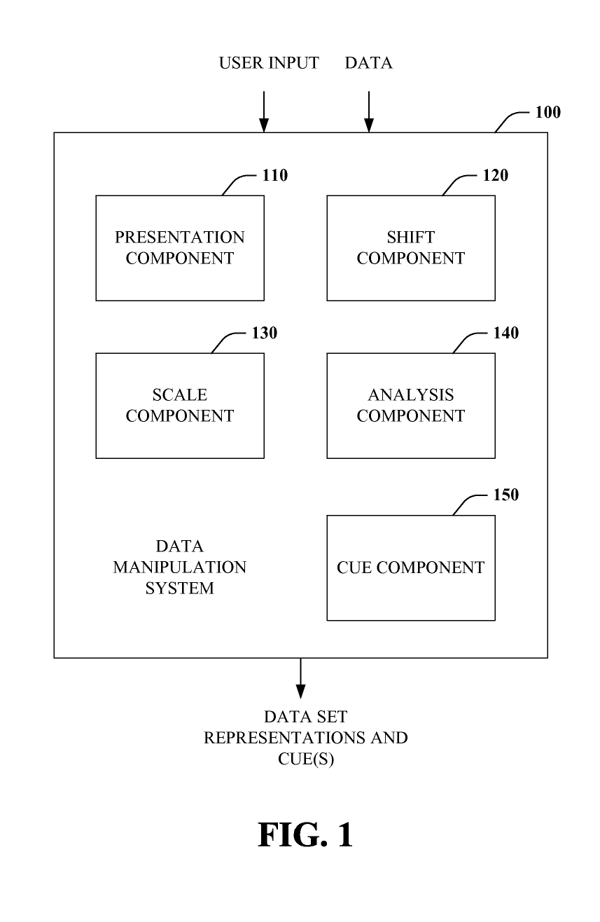

Referring initially to FIG. 1, a data manipulation system 100 is illustrated. Input to the data manipulation system 100 can include sets of data and user input. Output of the data manipulation system 100 can include representations of the data sets as well as one or more cues. Data sets can be acquired in many different ways. For example, data sets can be received, retrieved, or otherwise obtained locally or remotely from a computer-readable storage medium or input directly by a user. User input can be acquired by way of one or more input peripherals or devices such as a keyboard, mouse, trackball, touch screen, or microphone, among others. Output can be directed to one or more output peripherals or devices, such as directly to a display screen or microphone or indirectly, for example by way of a graphics processor. The data manipulation system 100 includes presentation component 110, shift component 120, scale component 130, analysis component 140, and cue component 150.

The presentation component 110 is configured to present or otherwise make available one or more data sets and one or more cues. For example, representations of data, such as graphs, and cues can be produced and encoded in a manner that enables presentation upon communication to an output peripheral such as a display (e.g., LCD screen). Accordingly, the presentation component 110 can be responsible for transforming data corresponding to representations and cues to an appropriate format for an output device and communicating the representation and cues to the output device. Further, while indicated as a single component, presentation component 110 can be embodied as multiple distinct components or subcomponents with respect to data sets and cues, for instance.

The shift component 120 is configured to allow directional movement of representations of data with respect to each other. In the context of graphical representations, for instance, the shift component 120 can allow graphs, or underlying data, to be transformed or translated in such a way that the location of the location of graphs is changed without changing the size and shape of graphs. In accordance with one implementation, each of a plurality of graphs of data sets can operate with respect to an independent set of axes and be overlaid in some manner. As a result, a first graph can be shifted or moved with respect to a second graph along one or more axes. By way of example and not limitation, a secondary x-axis can be employed that is scrollable independently. Furthermore, the shift component 120 can move representations in response to user input, which could be acquired by way of a touch screen, keyboard, mouse, or other input peripheral or device. In accordance with one embodiment, a user can move a graphical representation by way of interacting with one or more axes. According to another embodiment, a user can move a graphical representation more directly, for example by selecting, dragging, and dropping a graphical representation at desired position.

The scale component 130 is configured to enable representations of data to be scaled up or down. In a graphical representation context, the scale component 130 can allow a transformation or translation of one or more graphs, or underlying data, in a manner in which the size and shape of a graph are changed, and the location remains unchanged (unless transformed additionally with shift component 120). In accordance with one implementation, the scale component 130 can enable transformation of a data representation by applying a scale factor (e.g., a number) that enlarges or diminishes the data representation. For instance, graphs can have a similar pattern but a different scale. In this case, a first graph can be scaled by a factor to match a second graph. By way of example, and not limitation, consider a first time-series line graph that has a cycle of one year and a second time-series line graph that has a cycle of two years. The scale component 130 can allow the first graph to be scaled up twice to match the two-year cycle of the second graph. Alternatively, the second graph can be scaled down by half to match the one-year cycle of the first graph. Scaling can be enabled by the same or similar mechanism that enables directional shifting, namely representations that operate with respect to an independent set of axis that can be overlaid on top of each other. Furthermore, the scale component 130 can enlarge or diminish representations in response to user input, which could be acquired by way of a touch screen, keyboard, mouse, microphone, or other input peripheral or device. In accordance with one embodiment, a user can scale a graphical representation by way of interacting with one or more axes. Additionally or alternatively, a user can employ one or more gestures with respect to the graphical representation to perform scaling.

The analysis component 140 is configured to analyze data sets and compute useful metrics that to facilitate alignment of representations of the data sets. In one instance, the analysis component 140 can utilize one or more known or novel correlation algorithms such as linear correlation to compute correlation values for data sets. However, here, one or more correlation algorithms are applied to a plurality of combinations of data positioned relative to each other. In this manner, the gap or offset can be determined based on comparison of computed correlation values. For example, consider two time series graphs with an x-axis representing time from one unit to two hundred units. Suppose the offset between the two time series graphs on the x-axis is five units. Behind the scenes, the analysis component 140 can compute a correlation value, shift a graph one unit, compute another correlation value, and continue iteratively. The correlation values corresponding to different offsets, which represent the strength of alignment at different positions, can be compared and the offset with the highest correlation value identified as the desired shift or shift point. In other words, a brute force correlation approach can be employed. Of course, various optimizations can be employed.

For example, correlations values need not be computed for entire data sets. Data is often cyclic or seasonal. Accordingly, computation can be confined to a cyclic subset of data, if cycles can be detected or otherwise determined or inferred. Rather than computing and comparing correlation values for every point in a dataset, computation and comparison can be done with respect to a subset of data thus reducing the work performed with a brute force approach. Further, shift increments, such as time granularities, can be adjusted. For example, rather that computing correlation for an interval of an hour, correlation can be computed for an interval of a day or month. Decisions regarding subset identification and interval setting can be based on user input and/or other information or context pertaining to use of the data. Further yet, default seasonality can be applied to specific time granularities. For example, for daily data it can be sufficient to utilize three hundred and sixty five days, since that is the most common and largest cycle. For monthly data, the cycle or seasonality can be twelve. This knowledge can be learned from monitoring a field with telemetry.

Addtionally, correlation values or other metrics are not limited to shifting of data but can also be similarly employed with respect to other manipulations. For instance, metrics can be computed that can be employed to determine and subsequently scale data by a scale factor. By way of example, based on identification of cycles associated with each of two data sets, a scale factor can be determined and employed to scale data up or down. Another option is to use a visible size of a graphical window. This approach assumes that the user set the proper zoom of time series lines in a way that is meaningful and includes, for instance, the peaks or dips of the correlated series.

The cue component 150 is configured to generate one or more cues that provide information regarding manipulating one or more representations relative to each other. A cue is a signal that provides data that an individual may be interested in perceiving in the context of representation manipulation. For instance, a cue can provide a hint or suggestion that aids alignment of data sets as well as understanding of relations between data sets. A cue can be sensory in nature or, in other words, a sensory cue. A visual cue, for example, is a type of sensory cue that takes the form of something that can be seen such as but not limited to a symbol, icon, graphic, text, and/or image. While this detailed description focuses on visual cues, it is to be appreciated that any type of sensory cue can be utilized as well as a combination of different types of sensory cues. By way of example, and not limitation, auditory cues can be utilized alone or in combination with visual cues. For instance, the tone and/or frequency of a sound can be varied as a function of correlation.

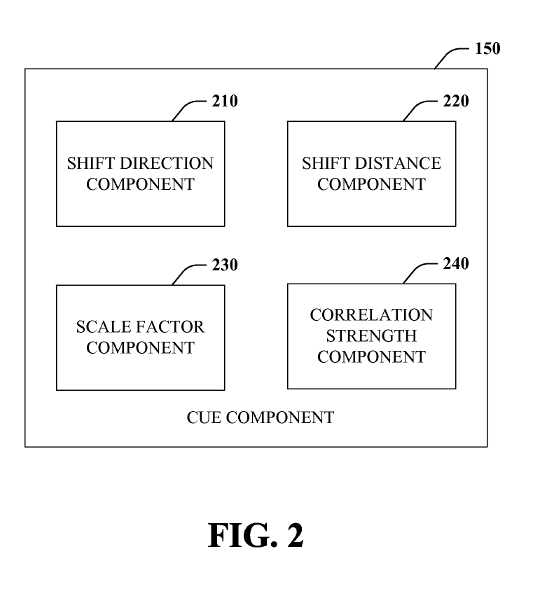

Turning attention to FIG. 2, a representative cue component 150 is illustrated in further detail. In particular, the cue component 150 includes shift direction component 210, shift distance component 220, scale factor component 230, and correlation strength component 240. Data for each of these subcomponents can be provided at least in part by the analysis component 140 of FIG. 1. The shift direction component 210 is configured to indicate a direction to shift or move a first representation of a first data set to a second representation of a second data set, for example. In accordance with one embodiment, the shift direction component 210 can indicate a direction toward stronger correlation. Additionally or alternatively, the shift direction component 210 can identify a direction toward weaker correlation. The shift distance component 220 is configured to indicate a distance, or in other words a magnitude, of a shift or move. In one instance, the distance can be between a current position and a suggested position based on correlation. In another instance, distance can be between a first position and a second shifted position that indicates the distance moved. The scale factor component 230 is configured to indicate scaling by some factor toward greater correlation and/or weaker correlation. For example, the scale factor can indicate that a data representation should be scaled up or down by some magnitude to correspond to another data representation. The correlation strength component 240 is configured to indicate the strength of correlation at one or more shift points and or scale factors. For example, an alignment that results in highest correlation can be marked as such. Additionally or alternatively, the strength of correlation can be indicated at other points. For example, the strength of correlation can be indicated at a current position. It is also to be appreciated that the shift direction component 210, the shift distance component 220, the scale factor component 230, and the correlation strength component 240 can be coordinated to produce various combinations of cues or composite cues.

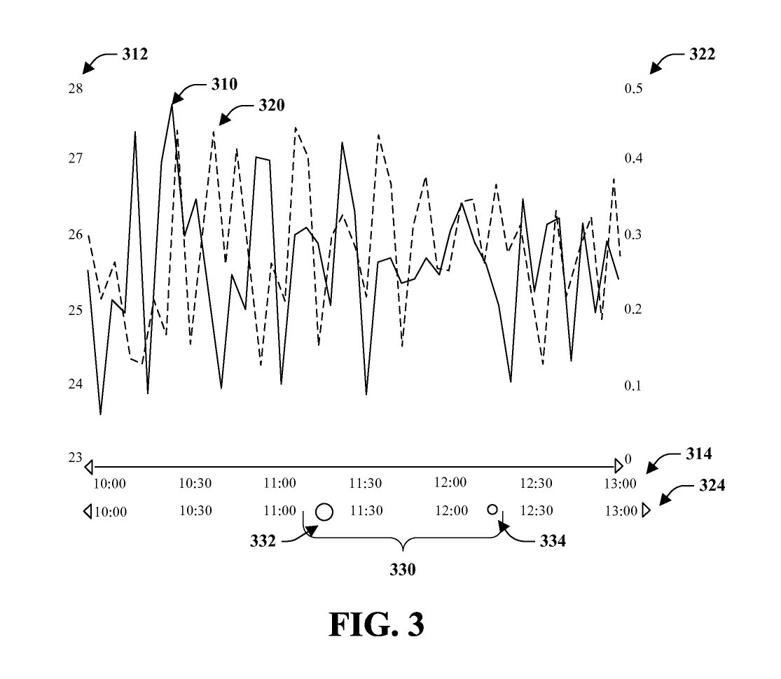

FIGS. 3-7 depict exemplary scenarios involving representation shifting and cues. Here, two graphical representations are discussed, namely time series graphs. More than two graphical representations are possible but solely two are discussed to facilitate clarity. The representations also need not be graphical representations or solely graphical representations, but rather can include other output such as sound, for example. Further, for simplicity in explanation and brevity, shifting is described along a single axis without scaling or other manipulation. It is also possible to perform shifting with respect to a different axis or multiple axes as well as other manipulations. Further yet, described cues are solely exemplary and are not to be limited thereto. Cues can be embodied in a number of different forms, combinations, and permutations. A few embodiments and combinations are shown solely for clarity and understanding with respect to aspects of the subject disclosure, but they are not intended to limit the claims thereto.

FIG. 3 illustrates an exemplary scenario comprising two time-series line graphs 310 and 320. The solid line graph 310 can represent temperature in degrees from twenty three to twenty eight as shown on y-axis 312 over time from ten to thirteen as shown on x-axis 314. The dashed line graph 320 can represent vapor pressure deficit (VPD) in kilopascals from zero to five tenths as shown on y-axis 322 over time from ten to thirteen as provided on x-axis 324. Visual inspection of graphs 310 and 320 may reveal a pattern but it is difficult to be sure, and it is challenging to quantify lag, if it is present. To aid determinations of at least correlation, the graphs 310 and 320 are presented on two different x-axes 314 and 324 that are independently scrollable, which allows the graphs to be shifted horizontally with respect to each other. Since the x-axes 314 and 324 represent time, such shifting can be referred to as time shifting. Alone, shifting is useful in allowing a user to attempt to align the graphs to detect patterns or relations. However, it is difficult to know where to start. Cue 330 is a composite cue comprising two circles positioned a distance apart on the x-axis 324 corresponding to graph 320. Circle 332 is larger than circle 334. The size of the circles or dots indicates strength of correlation at two different shift positions, wherein the larger circle 332 represents a higher value of correlation or strength of correlation than the smaller circle 334. The positioning of the circles 332 and 334 also indicates that if the graph 320 were shifted to the left, toward the larger circle 332, the result would be increased correlation, while if the graph 320 were shifted to the right, toward smaller circle 334, correlation would decrease. Furthermore, larger circle 332 can represent the strongest correlation. Accordingly, time shifting or aligning the graph to that point can represent the best correlation of data between the graphs, or in other words, the best alignment of the graph.

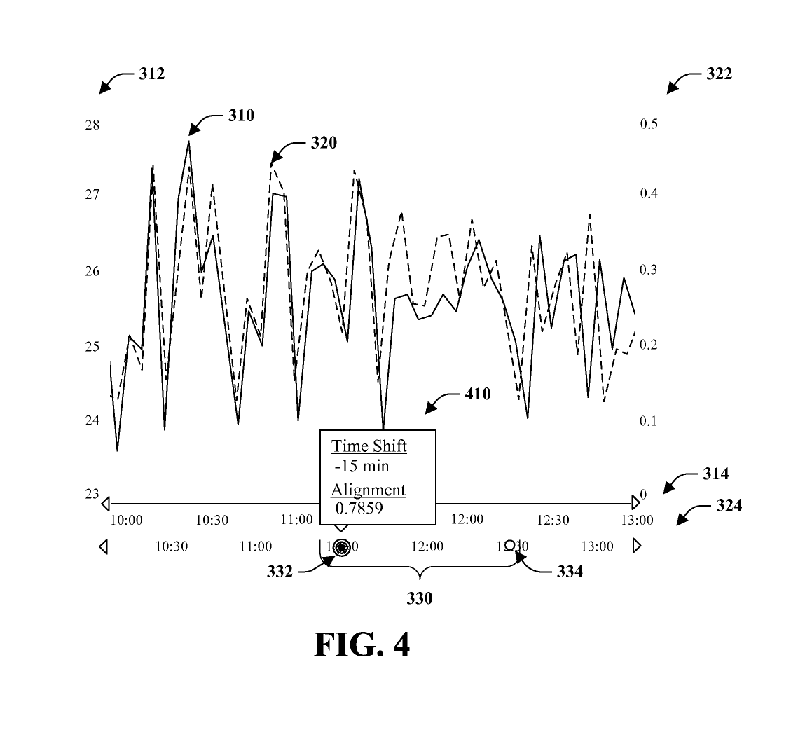

FIG. 4 illustrates a shifted version of the graphs 310 and 320 described above with respect to FIG. 3. Here, the graph 320 has been shifted to the left and now appears to align with graph 310. To effect this movement, a user employing an input device such as a touch screen display, mouse, or keyboard, moves the x-axis 324 to the left such that the time 11:30 is under or over the larger circle 332. The concentric circles over larger circle 332 indicate user selection and movement of x-axis 324 to the current location. An additional cue 410 is provided in response to the move that indicates in a text box the alignment percentage or correlation between the graph 310 and the graph 320 in view of the move. Further provided is the time shift, negative fifteen minutes, which represents the lag or offset of the graph 320 with respect to the graph 310.

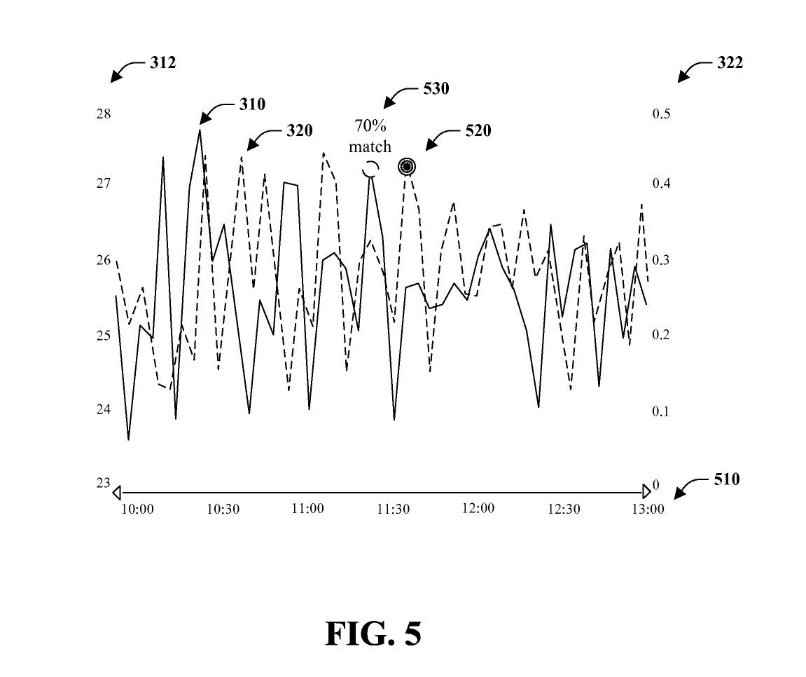

FIG. 5 illustrates an alternative interaction embodiment with respect to the graphs 310 and 320 described in FIG. 3. The solid line graph 310 can represent temperature in degrees from twenty three to twenty eight as shown on y-axis 312 over time from ten to thirteen as shown on x-axis 510. The dashed line graph 320 can represent vapor pressure deficit (VPD) in kilopascals from zero to five tenths as shown on y-axis 322 over time from ten to thirteen on x-axis 510. Here, a single x-axis 510 exists, and rather than specifying shifts with respect to a graph specific x-axis, movements can be made directly with respect to one or more of graphs 310 and 320. Concentric circles 520 represent selection of a point on the graph 320, for example based on touch on a tough screen or click of a mouse. The concentric circles 520 need not be shown but are presented here to indicate selection visually. Upon selection of a point on the graph, cue 530 can be presented that indicates another point, by way of a dashed circle, to which to move to at least improve or maximize data correlation. Further, the cue 530 can indicate the percentage match or correlation that would be achieved if the selected point were moved to the suggested point by shifting the graph 320 to the left a particular distance.

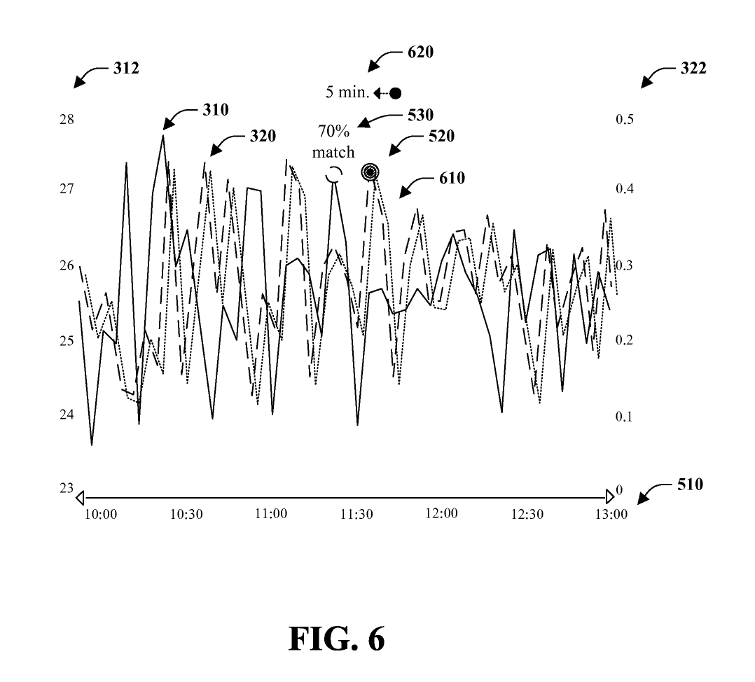

FIG. 6 illustrates a shifted version of the graphs 310 and 320. As depicted, the graph 320 is moved or shifted to the left slightly toward the suggested point identified by cue 530. For example, a user can select by touch or click and drag the graph 320 to the left. In response, a cue 610 corresponding to a depiction of the graph 320 in prior to shifting is illustrated as dashed graph. This visually indicates the movement made from a starting position. An additional cue 620 is provided that indicates direction and magnitude of the shift (e.g., vector), here to the left five minutes. In other words, the cue 620 communicates a time shift back five minutes. Although not illustrated, a cue can be provided that indicates the alignment percentage or correlation resulting from the shift.

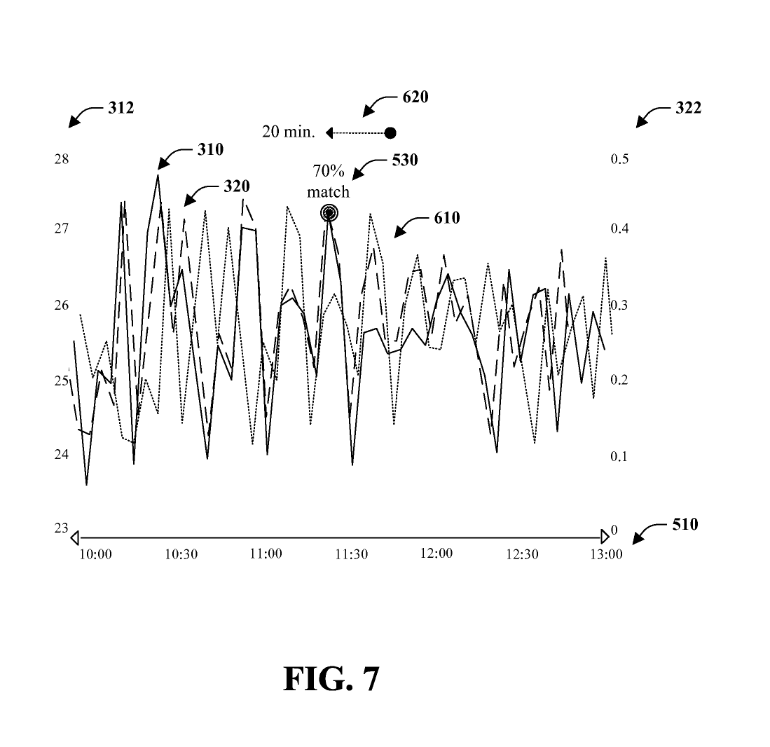

FIG. 7 depicts another shifted version of the graphs 310 and 320. In this instance, a selected point, here a peak, on graph 320 is shifted to the left to a point identified by cue 530 resulting in a seventy percent match or correlation. Cue 610 continues to represent the original, pre-shifted position of graph 320 to enable visualization of the distance shifted, or in other words, the magnitude of the shift. Additionally, cue 620 indicates the direction and magnitude of the shift, namely twenty minutes to the left or back in time. Note that in one instance, the graph 320 can remain in its shifted position until otherwise moved. Alternatively, the graph 320 can remain temporarily in its shifted position and subsequently and automatically snap back to its original, unshifted position, for example but removing a finger from the graph on a touchscreen or release of a depressed button on a mouse.

The exemplary scenarios presented with respect to FIGS. 3-7 are identified in statically black and white. It is to be appreciated that graphs and cues can be visually distinguished in other ways including use of color and/or animation, among other things. For example, graph 310 can be colored blue and graph 320 can be colored orange. As other non-limiting examples, information such as time shift and alignment can presented upon hovering over a point and/or a suggested shift point can flash or change color.

Additional cues can be generated and presented to aid analysis of shifted data. By way of example, and not limitation upon hovering over a portion of a realigned representation the difference between at least a point on one graph and a point on another graph can be indicated. For instance, the difference can be expresses quantitatively by a value and/or visually be coloring in the difference between the graphs to illustrate graph closeness. Furthermore, a standard deviation can be associated with a representation, and after two representations are aligned, an indication can be made that identifies values or portions of a graph that fall outside a predetermined standard deviation.

Discussion has been focused on two-dimensional representations of data and manipulation or transformation of such data. However, the claimed subject matter is not limited to two-dimensional representations but rather can be employed with respect to higher dimensions. For example, representations can be presented in three-dimensional space with respect to independent “x,” “y,” and “z” axes. Note also that additional or different manipulations may be available and useful with increased dimensions. In the context of three-dimensions, for instance, rotation of one representation with respect to another may produce increased correlation, which a cue can signal.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the analysis component 140 and/or the cue component 150 can employ such mechanisms in the computing correlation or other values as well as determining which of a plurality of cues to activate based on context information including how representations are presented, user preferences, and historical interaction, among other things.

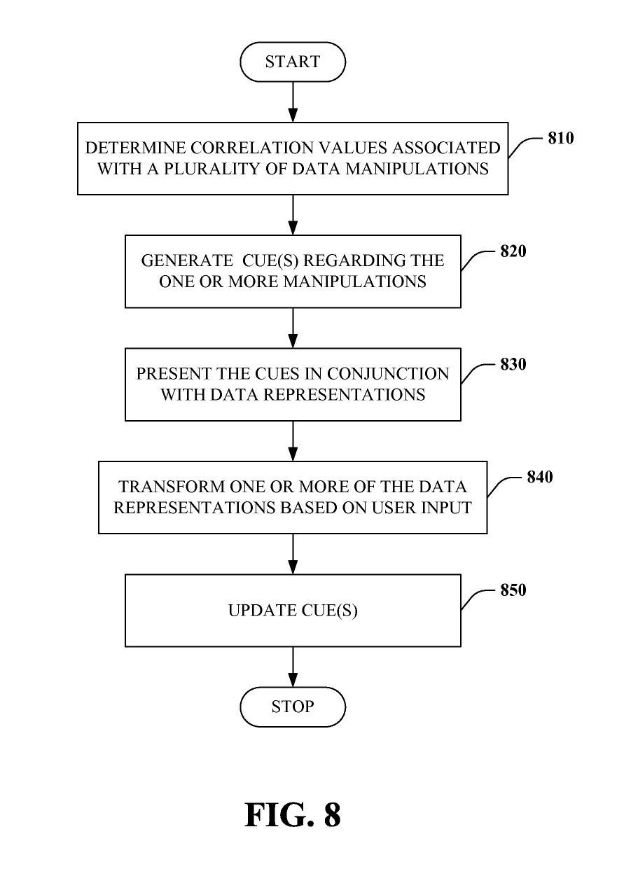

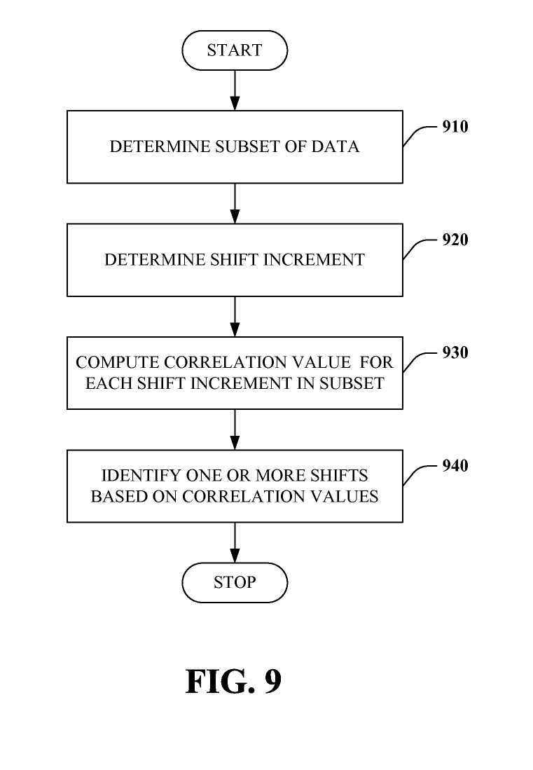

In view of the exemplary systems described above, methodologies that may be implemented in accordance with the disclosed subject matter will be better appreciated with reference to the flow charts of FIGS. 8 and 9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 8, a manipulation method is illustrated. At reference numeral 810, correlation values are determined with respect to a plurality of potential data manipulations. For instance, one or more known or novel correlation algorithms or approaches can be employed to compute correlation values resulting from various potential manipulations, such as, but not limited to linear correlation coefficient (a.k.a., R Squared).

By way of example, a value can be calculated by scanning two lines and measuring the accumulated distance (e.g., absolute difference) between pairs of points. An oversimplified example for purposes of clarity and understanding is as follows:

TABLE 1

| | | | | | | | | | |
|---|---|---|---|---|---|---|---|---|---|
| Series A: | N | N | 1 | 2 | 3 | 4 | 5 | N | N |
| Series B: | 1 | 2 | 3 | 4 | 5 | 6 | 7 | N | N |

TABLE 1 shows two series of data, “Series A” and “Series B,” wherein “N” denotes no data. If “Series B” is shifted one step at a time, after an offset of two units TABLE 2 results:

TABLE 2

| | | | | | | | | | |
|---|---|---|---|---|---|---|---|---|---|
| Series A: | N | N | 1 | 2 | 3 | 4 | 5 | N | N |
| Series B: | N | N | 1 | 2 | 3 | 4 | 5 | 6 | 7 |

A correlation algorithm, such as linear correlation coefficient, will ignore points “N” with no available data and accumulate the absolute distance between the lines. In this particular example, the evaluated lines are both “[1, 2, 3, 4, 5]” with a minimal distance of zero, which is the best correlation strength. Any other offset will result in a larger distance and hence two is the recommended shift. More advanced algorithms can also measure trend (e.g., rate of change) and scale tune the lines for correlation.

At numeral 820, one or more cues are generated regarding one or more manipulations. A cue corresponds to one or more signals that provision data that an individual may be interested in perceiving in the context of data manipulation. For instance, a cue can provide a hint or suggestion that aids alignment of data sets as well as understanding of relations between data sets. By way of example, and not limitation, a cue can identify a direction and magnitude of a shift as well as a scale factor that results in the strongest correlation amongst multiple data sets. With respect to the above example, the cue can suggest a shift of “Series B” by two units.

At reference 830, one or more generated cues can be presented in conjunction with representations of data such as but not limited to graphs. For example, a cue can be transformed into a format conducive to display and communicated to a display (e.g., LCD) of a computing device for visual presentation. In other words, a signal is presented on a display that provides information or cue regarding a suggested manipulation of a first representation of a first set of data, the suggested manipulation, when activated, transforms the first representation of the first set of data from a first mode to a second mode, the second mode providing better alignment between the first representation of the first set of data and a second representation of a second set of data than the first mode. For instance, in the example shown in FIGS. 3 and 4, the first mode represents graph 320 in FIG. 3; and the second mode represents graph 320 in FIG. 4 after x-axis 324 is shifted to the left based on cue 330 suggesting a manipulation by shifting x-axis 324 to the left, to achieve better alignment between graph 310 and graph 320. In the example shown in FIGS. 5-7, the first mode represents graph 320 in FIG. 5; and the second mode represents graph 320 in FIG. 6 or 7 after the graph is shifted to the left based on cue 530 suggesting a manipulation by shifting the graph to the left, to achieve better alignment between graph 310 and graph 320. As another example, a cue provides a suggested transformation of a graph by identifying a direction and magnitude of a shift of a graph or changing a scale factor of a graph that results in the strongest correlation amongst graphs representing multiple data sets. As an example, better alignment indicates that data sets represented by the graphs have a higher correlation value, such as a correlation coefficient, suggesting a stronger correlation between the data sets.

At reference 840, at least one representation of data is manipulated based on or in response to user input. For instance, the data associated with “Series B” can be transformed in a manner that shifts the data one or more units as specified by a user.

At reference numeral 850, one or more cues are updated based on the manipulation to provide pertinent information in view of the manipulation. Additionally, updating a cue can involve activating and presenting a cue that previously was not provided due to relevance or by design, for instance. By way of example, a cue can indicate the direction and distance of the shift as well as potential correlation at a current position.

Described above is a method that employs shifting of data. Of course, data manipulation is not limited to shifting but rather can encompass other transformations including but not limited to scaling or a combination of shifting and scaling, among others. With respect to scaling, a data series can be referred to as obtaining proportional presence in a presentation area to layout value labels. This goes in both directions. First, a representation or rendering of a data series (e.g., line, columns bars . . . ) can be automatically adjusted. Second, labels can be automatically adjusted to allow for better scaling of a representation. Additionally, note that scaling can be manually adjusted using zoom functionality similar to map navigation controls.

A correlation algorithm will perform several acts. For example, with respect to a graph, the visual space of the chart can be determined by computing maximum and minimum presentation label values. The data can be evaluated with respect to the maximum and minimum label values. The graph rendering of data can be evaluated. A determination can be made as to whether to perform optimization or not. An optimization can be based on the visual space, wherein if the minimum or maximum value is not in the visual space they can be ignored. Another optimization can be if data has a clear gap with no values, the algorithm can create a gap in the labels as well to account for the gap in data. Another optimization can be to add an additional axis in multiple data set scenarios. Yet another optimization can be transient transition of scaling for better user experience.

By way of simple example, consider a y-axis with visual labels from top to bottom between three and negative three. There can be an original data set in place. However, this can be ignored and recalculation of everything can be done. Now, a new set of data is provided, following a refresh, for example, that has the following (X, Y) pairs, “Y→3, 4, −1, 0” and “X→1, 2, 3, 4.” Here, the maximum “Y” is three and the minimum “Y” is negative one. In this case, the graph will be rescaled on the “Y” axis to account for a presentation label between negative one and three, removing negative two and negative three.

FIG. 9 is a flow chart diagram of a method of determining correlation values, for instance for use by cues. At reference numeral 910, a subset of data is determined Often data is cyclical, and a subset of data can correspond to one cycle of data. Cycles can be detected automatically by analyzing the data or with assistance from a user, for example. At numeral 920, a shift increment can be determined The shift increment can be explicitly specified, determined, or inferred. The data itself can inherently define a lower bound for a shift increment in terms of the specificity with which the data is captured. However, the shift intervals may be larger. By way of example, and not limitation, if data is involved in a forecast and it can be determined or inferred that the forecast is concerned with solely with daily results, as opposed to hourly results, provided by the data, then the shift interval can be set to a day. At numeral 930, a correlation value can be computed for each increment in the subset of data. More specifically, a correlation value between data of a first set and a second can be computed. Here, the correlation value is a measure of the strength of relationship (e.g., strong, weak, no relationship) between at least two data sets. Accordingly, linear correlation or other statistical measures can be computed to produce a value that indicates the strength of relationship (e.g., correlation coefficient). Subsequently, the first set can be shifted by the shift increment and a correlation value is computed between the first set of shifted data and the second set of data. At reference numeral 940, one or more shifts can be identified based on correlation values. For example, the shift (e.g., direction and magnitude) that results in the highest correlation value can be identified and optionally the shift that results in the lowest correlation value can be identified.

The subject disclosure supports various products and processes that perform, or are configured to perform, various actions regarding data manipulation cues. What follows are several exemplary methods, systems, and computer-readable storage mediums.

A method comprises employing at least one processor configured to execute computer-executable instructions stored in memory to perform the act of generating a cue that provides information regarding manipulating a first representation of a first set of data with respect to a second representation of a second set of data based on correlation between the first set of data and the second set of data. The method additionally includes the act of generating a cue that indicates at least one of a shift direction, strength of the correlation, shift distance, or a scale factor. The method further comprises manipulating the first representation with respect the second representation in response to a signal from a user, generating a cue that quantifies a manipulation, and generating a cue that quantifies the correlation between the first set of data and the second set of data after the manipulation.

A system comprises a processor coupled to a memory, the processor configured to execute the various computer-executable components stored in the memory including a first component configured to generate a visual cue regarding manipulation of a first graphical representation of a first set of data with respect to a second graphical representation of a second set of data based on correlation between the first set of data and the second set of data and a second component configured to communicate the visual cue to a display device for presentation in conjunction with the first graphical representation and the second graphical representation. The system further comprises components configured to generate a cue that indicate a shift direction toward stronger correlation, a cue that indicates correlation strength, a cue that indicates a shift distance that results in strongest correlation, and a cue that indicates a scale factor that results in strongest correlation. Furthermore, the system comprises a component configured to enable a shift of at least one of the first graphical representation and second graphical representation along at least one axis in response to a signal from a user. Further yet, the system comprises a component configured to determine correlation values associated with a plurality of shift increments within a subset of the first set of data and the second set of data.

A computer-readable storage medium having instructions stored thereon that enable at least one processor to perform a method upon execution of the instructions, the method comprises presenting a visual cue that provides information regarding manipulating a first representation of a first set of data with respect to a second representation of a second set of data based on correlation between the first set of data and the second set of data. The method further comprises presenting a visual cue that indicates shift direction toward a stronger correlation, strength of correlation, and shift distance that results in strongest correlation. The method still further comprises updating the visual cue after a manipulation.

In a computer configured to provide a graphical user interface on a display, a method comprises presenting on the display a first graphical representation of a first set of data and a second graphical representation of a second set of data, and presenting on the display a visual signal that provides information regarding a suggested manipulation of the first graphical representation of the first set of data, the suggested manipulation, when activated, transforms the first graphical representation of the first set of data from a first mode to a second mode, the second mode providing better visual alignment between the first graphical representation of the first set of data and the second graphical representation of the second set of data than the first mode. The method can further comprise receiving a user input activating the suggested manipulation, transforming the first graphical representation of the first set of data from the first mode to the second mode, and presenting on the display the first representation of the first set of data in the second mode and the second representation of the second set of data. The method can also comprise presenting on the display a visual signal that indicates at least one of magnitude or direction of movement of the first representation from the first mode to the second mode. Furthermore, the method can comprise presenting on the display a visual signal that indicates shift magnitude and direction of the suggested manipulation.

A computer-readable storage medium having instructions stored thereon that enable at least one processor to perform a method upon execution of the instructions, the method comprises presenting on a display a first graphical representation of a first set of data and a second graphical representation of a second set of data, and presenting on the display a visual signal that provides information regarding a suggested manipulation of the first graphical representation of the first set of data, the suggested manipulation, when activated, transforms the first graphical representation of the first set of data from a first mode to a second mode, the second mode providing better visual alignment between the first graphical representation of the first set of data and the second graphical representation of the second set of data than the first mode. The method can further comprise receiving a user input activating the suggested manipulation, transforming the first graphical representation of the first set of data from the first mode to the second mode, and presenting on the display the first representation of the first set of data in the second mode and the second representation of the second set of data. The method can further comprise presenting on the display a visual signal that indicates at least one of magnitude or direction of movement of the first representation from the first mode to the second mode. Further yet, the method can comprise presenting on the display a visual signal that indicates shift magnitude and direction of the suggested manipulation.

A system comprises a processor coupled to a memory, the processor configured to execute the following computer-executable component stored in the memory: a first component configured to present on a display a first graphical representation of a first set of data and a second graphical representation of a second set of data, and a second component configured to present on the display a visual signal that provides information regarding a suggested manipulation of the first graphical representation of the first set of data, the suggested manipulation, when activated, transforms the first graphical representation of the first set of data from a first mode to a second mode, the second mode providing better visual alignment between the first graphical representation of the first set of data and the second graphical representation of the second set of data than the first mode. The system can further comprise components configured to receive user input to activate the suggested manipulation, transform the first graphical representation of the first set of data from the first mode to the second mode, and present on the display the first representation of the first set of data in the second mode and the second representation of the second set of data. Furthermore, the system can include a component configured to present on the display a visual signal that indicates at least one of magnitude or direction of movement of the first representation from the first mode to the second mode. Additionally, the system can include a component configured to present on the display a visual signal that indicates shift magnitude and direction of the suggested manipulation.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

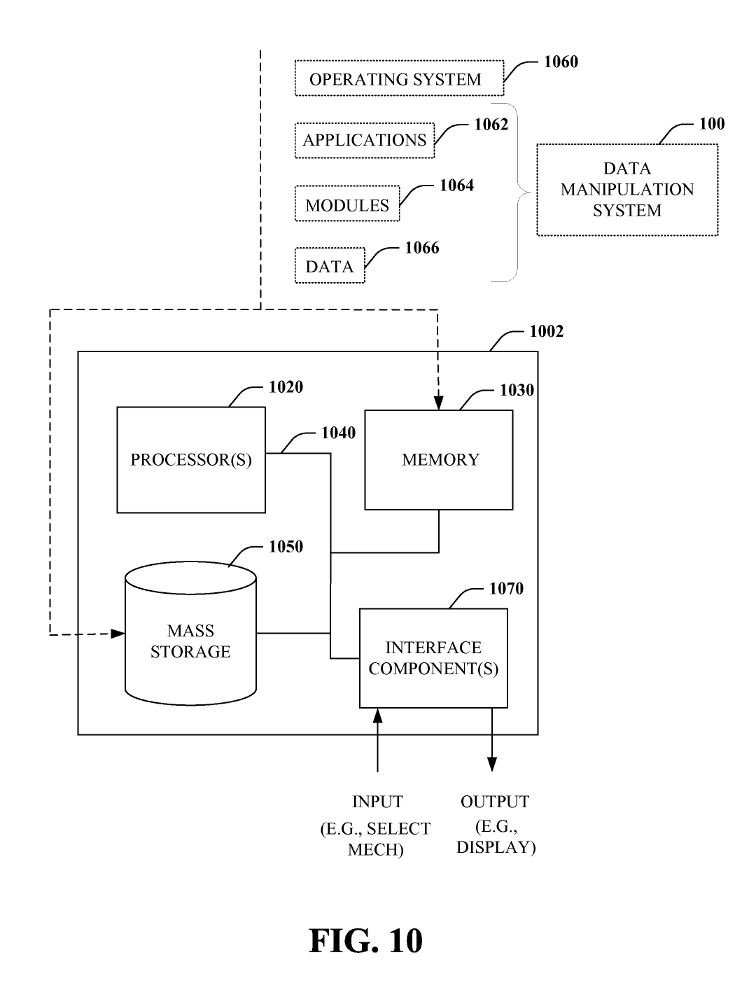

In order to provide a context for the claimed subject matter, FIG. 10 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 10, illustrated is an example general-purpose computer or computing device 1002 (e.g., desktop, laptop, tablet, server, hand-held, programmable consumer or industrial electronics, set-top box, game system, compute node . . . ). The computer 1002 includes one or more processor(s) 1020, memory 1030, system bus 1040, mass storage 1050, and one or more interface components 1070. The system bus 1040 communicatively couples at least the above system components. However, it is to be appreciated that in its simplest form the computer 1002 can include one or more processors 1020 coupled to memory 1030 that execute various computer executable actions, instructions, and or components stored in memory 1030.

The processor(s) 1020 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1020 may also be implemented as a combination of computing devices, for example a combination of a DSP and a microprocessor, a plurality of microprocessors, multi-core processors, one or more microprocessors in conjunction with a DSP core, or any other such configuration.

The computer 1002 can include or otherwise interact with a variety of computer-readable media to facilitate control of the computer 1002 to implement one or more aspects of the claimed subject matter. The computer-readable media can be any available media that can be accessed by the computer 1002 and includes volatile and nonvolatile media, and removable and non-removable media. Computer-readable media can comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that can be used to store, as opposed to transmit, the desired information accessible by the computer 1002. Accordingly, computer storage media excludes modulated data signals.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1030 and mass storage 1050 are examples of computer-readable storage media. Depending on the exact configuration and type of computing device, memory 1030 may be volatile (e.g., RAM), non-volatile (e.g., ROM, flash memory . . . ) or some combination of the two. By way of example, the basic input/output system (BIOS), including basic routines to transfer information between elements within the computer 1002, such as during start-up, can be stored in nonvolatile memory, while volatile memory can act as external cache memory to facilitate processing by the processor(s) 1020, among other things.

Mass storage 1050 includes removable/non-removable, volatile/non-volatile computer storage media for storage of large amounts of data relative to the memory 1030. For example, mass storage 1050 includes, but is not limited to, one or more devices such as a magnetic or optical disk drive, floppy disk drive, flash memory, solid-state drive, or memory stick.

Memory 1030 and mass storage 1050 can include, or have stored therein, operating system 1060, one or more applications 1062, one or more program modules 1064, and data 1066. The operating system 1060 acts to control and allocate resources of the computer 1002. Applications 1062 include one or both of system and application software and can exploit management of resources by the operating system 1060 through program modules 1064 and data 1066 stored in memory 1030 and/or mass storage 1050 to perform one or more actions. Accordingly, applications 1062 can turn a general-purpose computer 1002 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, data manipulation system or portions thereof can be or form part, of an application 1062, and include one or more modules 1064 and data 1066 stored in memory and/or mass storage 1050 whose functionality can be realized when executed by one or more processor(s) 1020.

In accordance with one particular embodiment, the processor(s) 1020 can correspond to a system on a chip (SOC) or like architecture including, or in other words integrating, both hardware and software on a single integrated circuit substrate. Here, the processor(s) 1020 can include one or more processors as well as memory at least similar to processor(s) 1020 and memory 1030, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the data manipulation system 100 and/or associated functionality can be embedded within hardware in a SOC architecture. The computer 1002 also includes one or more interface components 1070 that are communicatively coupled to the system bus 1040 and facilitate interaction with the computer 1002. By way of example, the interface component 1070 can be a port (e.g., serial, parallel, PCMCIA, USB, FireWire . . . ) or an interface card (e.g., sound, video . . . ) or the like. In one example implementation, the interface component 1070 can be embodied as a user input/output interface to enable a user to enter commands and information into the computer 1002, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 1070 can be embodied as an output peripheral interface to supply output to displays (e.g., LCD, LED, plasma . . . ), speakers, printers, and/or other computers, among other things. For example, the computer 1002 can provide graphical user interface, including a display (e.g., LCD, LED, plasma monitor) and selection mechanism (e.g., touch screen, mouse, keyboard . . . . ), that presents one or more visual cues that indicate a manipulation to achieve alignment between at least two graphical representations of data. Still further yet, the interface component 1070 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
employing at least one processor configured to execute computer-executable instructions stored in memory to perform the following act:
generating a cue that provides information regarding manipulating a first representation of a first set of data with respect to a second representation of a second set of data based on correlation between the first set of data and the second set of data.

2. The method of claim 1 further comprises generating a cue that indicates a shift direction.

3. The method of claim 1 further comprises generating a cue that indicates strength of the correlation.

4. The method of claim 1 further comprises generating a cue that indicates shift distance.

5. The method of claim 1 further comprises generating a cue that indicates a scale factor.

6. The method of claim 1 further comprises manipulating the first representation with respect the second representation in response to a signal from a user.

7. The method of claim 6 further comprises generating a cue that quantifies a manipulation.

8. The method of claim 6 further comprises generating a cue that quantifies correlation between the first set of data and the second set of data after the manipulation.

9. A system, comprising:
a processor coupled to a memory, the processor configured to execute the following computer-executable components stored in the memory:
a first component configured generate a visual cue regarding manipulation of a first graphical representation of a first set of data with respect to a second graphical representation of a second set of data based on correlation between the first set of data and the second set of data; and
a second component configured to communicate the visual cue to a display device for presentation in conjunction with the first graphical representation and the second graphical representation.

10. The system of claim 9 further comprises a third component configured to generate a cue that indicates a shift direction toward stronger correlation.

11. The system of claim 9 further comprises a third component configured to generate a cue that indicates correlation strength.

12. The system of claim 9 further comprises a third component configured to generate a cue that indicates a shift distance that results in strongest correlation.

13. The system of claim 9 further comprises a third component configured to generate a cue that indicates a scale factor that results in strongest correlation.

14. The system of claim 9 further comprises a third component configured to enable a shift of at least one of the first graphical representation and second graphical representation along at least one axis in response to a signal from a user.

15. The system of claim 9 further comprises a third component configured to determine correlation values associated with a plurality of shift increments within a subset of the first set of data and the second set of data.

16. A computer-readable storage medium having instructions stored thereon that enable at least one processor to perform a method upon execution of the instructions, the method comprising:
presenting a visual cue that provides information regarding manipulating a first representation of a first set of data with respect to a second representation of a second set of data based on correlation between the first set of data and the second set of data.

17. The computer-readable storage medium of claim 16, the method further comprises presenting a visual cue that indicates a shift direction toward a stronger correlation.

18. The computer-readable storage medium of claim 16, the method further comprises presenting a visual cue that indicates strength of correlation.

19. The computer-readable storage medium of claim 16, the method further comprises presenting a visual cue that indicates shift distance that results in strongest correlation.

20. The computer-readable storage medium of claim 16, the method further comprises updating the visual cue after a manipulation.

21. In a computer configured to provide a graphical user interface on a display, a method comprising:
presenting on the display a first graphical representation of a first set of data and a second graphical representation of a second set of data; and
presenting on the display a visual signal that provides information regarding a suggested manipulation of the first graphical representation of the first set of data, the suggested manipulation, when activated, transforms the first graphical representation of the first set of data from a first mode to a second mode, the second mode providing better visual alignment between the first graphical representation of the first set of data and the second graphical representation of the second set of data than the first mode.

22. The method of claim 21 further comprising:
receiving a user input activating the suggested manipulation;
transforming the first graphical representation of the first set of data from the first mode to the second mode; and
presenting on the display the first representation of the first set of data in the second mode and the second representation of the second set of data.

23. The method of claim 22 further comprises presenting on the display a visual signal that indicates at least one of magnitude or direction of movement of the first representation from the first mode to the second mode.

24. The method of claim 21 further comprises presenting on the display a visual signal that indicates shift magnitude and direction of the suggested manipulation.

25. The method of claim 21, better visual alignment represents that the first set of data and the second set of data have a higher level of correlation.

26. A computer-readable storage medium having instructions stored thereon that enable at least one processor to perform a method upon execution of the instructions, the method comprising:
presenting on a display a first graphical representation of a first set of data and a second graphical representation of a second set of data; and
presenting on the display a visual signal that provides information regarding a suggested manipulation of the first graphical representation of the first set of data, the suggested manipulation, when activated, transforms the first graphical representation of the first set of data from a first mode to a second mode, the second mode providing better visual alignment between the first graphical representation of the first set of data and the second graphical representation of the second set of data than the first mode.

27. The computer-readable storage medium of claim 26, the method further comprising:
receiving a user input activating the suggested manipulation;
transforming the first graphical representation of the first set of data from the first mode to the second mode; and
presenting on the display the first representation of the first set of data in the second mode and the second representation of the second set of data.

28. The computer-readable storage medium of claim 27, the method further comprises presenting on the display a visual signal that indicates at least one of magnitude or direction of movement of the first representation from the first mode to the second mode.

29. The computer-readable storage medium of claim 26, the method further comprises presenting on the display a visual signal that indicates shift magnitude and direction of the suggested manipulation.

30. The method of claim 26, better visual alignment represents that the first set of data and the second set of data have a higher level of correlation.

31. A system, comprising:
a processor coupled to a memory, the processor configured to execute the following computer-executable component stored in the memory:
a first component configured to present on a display a first graphical representation of a first set of data and a second graphical representation of a second set of data; and
a second component configured to present on the display a visual signal that provides information regarding a suggested manipulation of the first graphical representation of the first set of data, the suggested manipulation, when activated, transforms the first graphical representation of the first set of data from a first mode to a second mode, the second mode providing better visual alignment between the first graphical representation of the first set of data and the second graphical representation of the second set of data than the first mode.

32. The system of claim 31 further comprising:
a third component configured to receive user input to activate the suggested manipulation;
a fourth component configured to transform the first graphical representation of the first set of data from the first mode to the second mode; and
a fifth component configured to present on the display the first representation of the first set of data in the second mode and the second representation of the second set of data.

33. The system of claim 31 further comprising a sixth component configured to present on the display a visual signal that indicates at least one of magnitude or direction of movement of the first representation from the first mode to the second mode.

34. The system of claim 31, the second component is configured to present on the display a visual signal that indicates shift magnitude and direction of the suggested manipulation.

35. The system of claim 31, better visual alignment represents that the first data set and the second data set have a higher level of correlation.
